(19) United States
(12) Patent Application Publication
(10) Pub. No.: US 2017/0346560 A1
(43) Pub. Date: Nov. 30, 2017

(54) Method of Messaging with Light

(71) Applicant: Pin-Chih Lin, Taipei City (TW)

(72) Inventor: Pin-Chih Lin, Taipei City (TW)

(21) Appl. No.: 15/488,873

(22) Filed: Apr. 17, 2017

Related U.S. Application Data
(60) Provisional application No. 62/342,269, filed on May 27, 2016.

(30) Foreign Application Priority Data
Oct. 31, 2016 (TW) 105135236

(51) Int. Cl. H04B 10/116; H04B 10/60; H04B 10/54; H05B 33/08; H04B 10/50

(52) U.S. Cl. CPC H04B 10/116; H05B 33/0845; H04B 10/502; H04B 10/541; H04B 10/60

(57) ABSTRACT

A method of messaging with light is implemented by a light fixture. The method includes: timing and recording a switch-on period, and recording an operation mode of the light fixture during receipt of the electrical power; and operating in a messaging mode the next time the light fixture receives electrical power upon determining that the recorded operation mode is a lighting mode and that the recorded switch-on period is within a predetermined range of time period. In the messaging mode, the light fixture controls a light emitting device to send a binary message by operating in a sequence composed at least of a first brightness state and/or a second brightness state.

### CROSS-REFERENCE TO RELATED APPLICATION

This application claims priorities of U.S. Provisional Patent Application No. 62/342,269, filed on May 27, 2016, and Taiwanese Patent Application No. 105135236, filed on Oct. 31, 2016.

### FIELD

The disclosure relates to a method of messaging with light.

### BACKGROUND

A conventional light emitting diode (LED) light fixture with remote control uses wireless communication technology, such as infrared, Wi-Fi, Bluetooth, Zigbee, etc., to control brightness of light emitted by the LED(s) and to inspect a condition of the light fixture, such as power consumption, watts, temperature, power factor, current, voltage, abnormality, etc. However, use of the wireless communication requires installation of a transmitter and a receiver in the light fixture and the remote controller, resulting in higher production cost and greater complexity.

### SUMMARY

Therefore, an object of the disclosure is to provide a method of messaging with light that may have a relatively low cost and low complexity.

According to the disclosure, the method is implemented by a light fixture that controls light emission of a light emitting device. The method includes steps of: (a) timing and recording a switch-on period from a beginning of receipt of electrical power until the receipt of electrical power is stopped, and recording an operation mode of the light fixture during the receipt of the electrical power; and (b) operating in a messaging mode upon determining, at a beginning of receipt of electrical power following stoppage of the receipt of electrical power in step (a), that the operation mode recorded in step (a) is a lighting mode and that the switch-on period recorded in step (a) is within a predetermined range of time period. In the messaging mode, the light fixture controls the light emitting device to send a binary message by operating in a sequence composed at least of a first brightness state and/or a second brightness state. The light fixture controls light emission of the light emitting device such that brightness of light emitted by the light emitting device in the first brightness state is different from that in the second brightness state.

### BRIEF DESCRIPTION OF THE DRAWINGS

Other features and advantages of the disclosure will become apparent in the following detailed description of the embodiment (s) with reference to the accompanying drawings, of which:

FIG. 1 is a circuit block diagram illustrating a control device of a light fixture, a light emitting device and a light switch that cooperate to implement embodiments of the method of messaging with light according to the disclosure;

FIG. 2 shows a state machine of a first embodiment of the method of messaging with light according to the disclosure; and

FIG. 3 shows a state machine of a second embodiment of the method of messaging with light according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

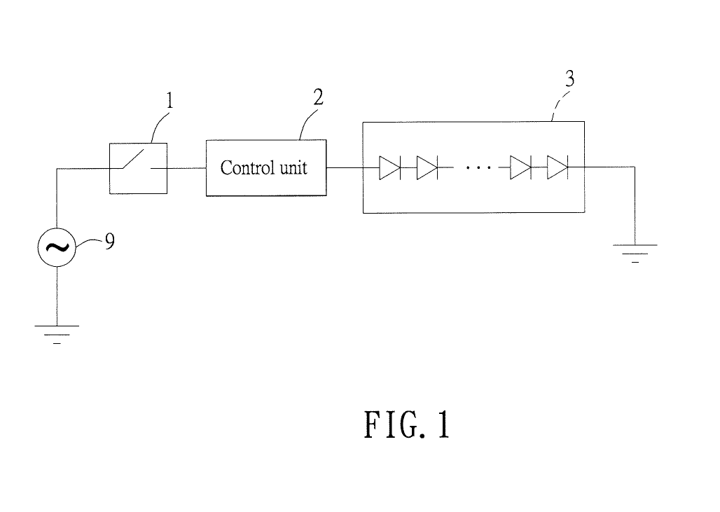

Referring to FIG. 1, a light fixture for implementing the embodiments of the method of messaging with light according to this disclosure is shown to include a control device 2 that is coupled to an alternating current (AC) power source 9 through a light switch 1 for receiving electrical power when the light switch 1 conducts, and that is coupled to a light emitting device 3. In this embodiment, the light emitting device 3 is exemplified using an LED device. When the light switch 1 conducts, the control device 2 operates in one of a lighting mode and a messaging mode to control light emission of the light emitting device 3. When the light switch 1 does not conduct, the control device 2 and the light emitting device 3 do not operate due to lack of electrical power. In this embodiment, the AC power source 9 is mains electricity and the light switch 1 is a manually operated switch which is operable by hand. It is noted that, either the light switch 1 or the light emitting device 3 may be included in the light fixture as a commodity in other embodiments.

When the light switch 1 conducts (i.e., the control device 2 receives the electrical power from the AC power source 9, and the light fixture is turned on), the control device 2 times and records a switch-on period from a beginning of receipt of the electrical power until receipt of the electrical power is stopped (e.g., the light switch 1 is switched to “OFF”). The control device 2 further records an operation mode (e.g., the lighting mode or the messaging mode) thereof during receipt of the electrical power. In this embodiment, the control device 2 may include a non-volatile storage medium, such as a flash memory, so that the recorded switch-on period and the recorded operation mode may be maintained when the light switch 1 does not conduct (i.e., the control device 2 does not receive the electrical power from the AC power source 9). The next time the light switch 1 conducts, the control device 2 reads from the non-volatile storage medium the recorded switch-on period and the recorded operation mode so as to determine a new operation mode. It is noted that, in other embodiments, the control device 2 may include a storage module (e.g., a RAM module) for data storage, and receives electricity (e.g., from a battery) to maintain storage of the recorded switch-on period and the recorded operation mode when the light switch 1 does not conduct.

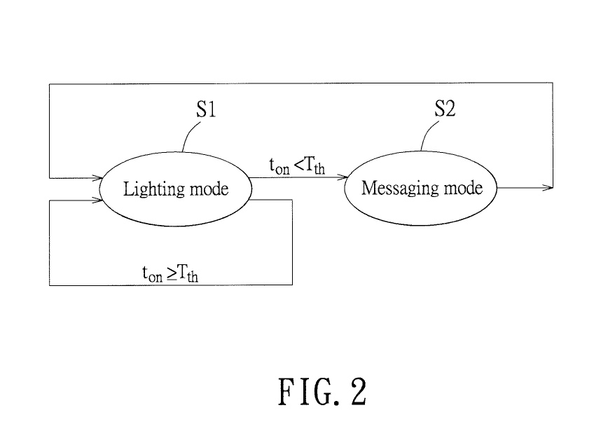

FIG. 2 shows a state machine of a first embodiment of the method of messaging with light according to this disclosure. When the control device 2 determines, at a beginning of receipt of the electrical power (i.e., at the time the light switch 1 is switched to “ON”), that the operation mode recorded at the last time the light fixture is turned on is the messaging mode (S2), the control device 2 operates in the lighting mode (S1) to control the light emitting device 3 to emit light with a predetermined brightness. In this embodiment, the control device 2 controls the light emitting device 3 to emit light with a maximum brightness in the lighting mode.

When the control device 2 determines, at the beginning of receipt of the electrical power, that the recorded operation mode is the lighting mode (S1) and that the recorded switch-on period (tₒₙ) is not shorter than a threshold period (Tₜₕ), the control device 2 continues to operate in the lighting mode (S1). In this embodiment, the threshold period (Tₜₕ) is five seconds, but this disclosure is not limited to such.

When the control device 2 determines, at the beginning of receipt of the electrical power, that the recorded operation mode is the lighting mode (S1) and that the recorded switch-on period (tₒₙ) is shorter than the threshold period (Tₜₕ), the control device 2 operates in the messaging mode (S2) to control the light emitting device 3 to send a binary message by operating in a selective sequence composed of a first brightness state, a second brightness state or a third brightness state in which the light emitting device 3 provides different brightness. The first brightness state and the second brightness state may respectively represent binary values of “1” and “0”, and the third brightness state indicates a beginning of the binary message. For each bit of the binary message, the light fixture controls the light emitting device 3 to operate in a respective one of the first brightness state and the second brightness state for a first predetermined time length (e.g., one second). In addition, the light fixture controls the light emitting device 3 to operate in the third brightness state for a second predetermined time length to indicate the beginning of the binary message. In this embodiment, the first predetermined time length is equal to the second predetermined time length, and the binary message is a natural binary code, but this disclosure is not limited thereto. In this embodiment, the control device 2 controls the light emitting device 3 to emit light with the maximum brightness in the first brightness state, to emit light with 50% of the maximum brightness in the second brightness state, and to not emit light in the third brightness state, but this disclosure is not limited thereto.

In an example that a user manually switches on the light switch 1 for three seconds during which the control device 2 operates in the lighting mode (S1), then switches off the light switch 1 (i.e., the switch-on period is three seconds), and then switches on the light switch 1 again, at the second instance of switching on the light switch 1, the control device 2 operates in the messaging mode (S2), and controls the light emitting device 3 to, for example, not emit light for one second (representing a beginning of a binary message), emit light with the maximum brightness for one second, emit light with 50% of the maximum brightness for one second, emit light with the maximum brightness for one second, emit light with 50% of the maximum brightness for two seconds, and does not emit light for one second (representing a beginning of the next binary message, and also an end of the binary message), in the given sequence, to provide a binary message “10100”.

In this embodiment, the binary message represents a condition of use of the light fixture, such as power consumption, watts, temperature, power factor, current voltage, abnormality, or a combination thereof. The condition of use may be acquired by computing according to a voltage or a current that is provided to the light emitting device 3, or through detection by a sensor installed in the light fixture, and the disclosure is not limited to such. As an example, the abovementioned binary message “10100” may represent 20 watts based on the natural binary code.

In this embodiment, the user may be aware of the condition of the light fixture according to the flashing of the light emitting device 3 that is provided in the messaging mode (S2). In other embodiments, an image capturing device, such as a smartphone, may be used to receive light emitted by the light emitting device 3 for decoding the binary message. In one embodiment, the control device 2 further controls the light emitting device 3 to send, prior to sending the binary message, a binary header by operating in a selective sequence of the first brightness state, the second brightness state or the third brightness state when the control device 2 operates in the messaging mode (S2). The binary header may be, for example, “10101010” that is repeated for four times for synchronous processing of the image capturing device. In one embodiment, the binary message may be a message after communication coding, such as Trellis code, Manchester code, Morse code, etc.

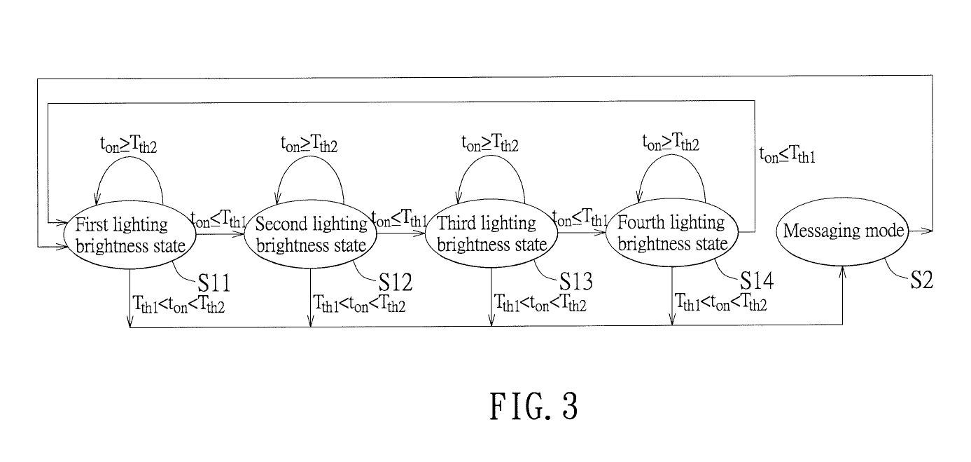

Referring to FIGS. 1 and 3, FIG. 3 exemplifies a state machine of a second embodiment of the method of messaging with light according to this disclosure. The second embodiment differs from the first embodiment in that the lighting mode includes multiple lighting brightness states that are arranged in a predetermined sequence (e.g., brightness states (S11 to S14) as exemplified in FIG. 3) in the second embodiment. In each of the lighting brightness states, the control device 2 controls the light emitting device 3 to emit light with a corresponding, distinct brightness. In this example, the control device 2 further records the light brightness state thereof when the operation mode is the lighting mode during receipt of the electrical power.

In the example as shown in FIG. 3, when the control device 2 determines, at the beginning of receipt of the electrical power, that the recorded operation mode is the messaging mode (S2), the control device 2 operates in the lighting brightness state (S11).

When the control device 2 determines, at the beginning of receipt of the electrical power, that the recorded operation mode is the lighting mode under one of the lighting brightness states (S11-S14) and that the recorded switch-on period (tₒₙ) is longer than a first threshold period (Tₜₕ₁, e.g., five seconds) and shorter than a second threshold period (Tₜₕ₂, e.g., one minute), the control device 2 operates in the messaging mode (S2).

When the control device 2 determines, at the beginning of receipt of the electrical power, that the recorded operation mode is the lighting mode under the i^{th} one of the lighting brightness states (e.g., the lighting brightness states (S11-S13)), and that the recorded switch-on period (tₒₙ) is not longer than the first threshold period (Tₜₕ₁), the control device 2 operates in the lighting mode under the (i+1)^{th} one of the lighting brightness states (e.g., the lighting brightness states (S12-S14)), where i is a positive integer smaller than a number of the lighting brightness states (e.g., four).

When the control device 2 determines, at the beginning of receipt of the electrical power, that the recorded operation mode is the lighting mode under the last one of the lighting brightness states (e.g., the lighting brightness state (S14)), and that the recorded switch-on period (tₒₙ) is not longer than the first threshold period (Tₜₕ₁), the control device 2 operates in the lighting mode under the first one of the lighting brightness states (e.g., the lighting brightness state (S11)).

When the control device 2 determines, at the beginning of receipt of the electrical power, that the recorded operation mode is the lighting mode under one of the lighting brightness states (e.g., one of the lighting brightness states (S11-S14)), and that the recorded switch-on period (tₒₙ) is not shorter than the second threshold period (Tₜₕ₂), the control device 2 operates in the lighting mode under said one of the lighting brightness states (i.e., to keep operating in the same lighting brightness state).

In one implementation, at least two of the first brightness state, the second brightness state or the third brightness state of the messaging mode respectively correspond to at least two of the lighting brightness states of the lighting mode in terms of brightness. For example, when the control device 2 controls the light emitting device 3 to emit light with the maximum brightness, 75% of the maximum brightness, 50% of the maximum brightness and 25% of the maximum brightness respectively in the lighting brightness states (S11-S14), the control device 2 may control the light emitting device 3 to emit light with the maximum brightness and 50% of the maximum brightness respectively in the first and second brightness states, and to not emit light in the third brightness state, or, the control device 2 may control the light emitting device 3 to emit light with the maximum brightness, 50% of the maximum brightness and 25% of the maximum brightness respectively in the first, second and third brightness states. It is noted that a total number of the lighting brightness states may be any desired positive integer that is greater than one, and this disclosure is not limited thereto.

In summary, by virtue of the control device 2 recording the operation mode thereof and the switch-on period, the user may use the light fixture to control the light emitting device 3 to operate in the messaging state to send a binary message by flashing the next time the light switch 1 is switched on. A method of messaging with light with relatively low cost and low complexity may thus be realized, and may cause the user to be aware of the condition of use of the light fixture by the naked eye or by the image capturing device.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of messaging with light, said method being implemented by a light fixture that controls light emission of a light emitting device, said method comprising steps of:
(a) timing and recording a switch-on period from a beginning of receipt of electrical power until the receipt of electrical power is stopped, and recording an operation mode of the light fixture during the receipt of the electrical power; and
(b) operating in a messaging mode upon determining, at a beginning of receipt of electrical power following stoppage of the receipt of electrical power in step (a), that the operation mode recorded in step (a) is a lighting mode and that the switch-on period recorded in step (a) is within a predetermined range;
wherein, in the messaging mode, the light fixture controls the light emitting device to send a binary message by operating in a sequence composed at least of a first brightness state and/or a second brightness state; and
wherein the light fixture controls light emission of the light emitting device such that brightness of light emitted by the light emitting device in the first brightness state is different from that in the second brightness state.

2. The method of claim 1, wherein the binary message is associated with a condition of the light fixture.

3. The method of claim 1, wherein step (b) includes operating in the messaging mode upon determining, at the beginning of the receipt of electrical power following stoppage of the receipt of electrical power in step (a), that the operation mode recorded in step (a) is the lighting mode and that the switch-on period recorded in step (a) is shorter than a threshold period.

4. The method of claim 3, further comprising a step of: (c) operating in the lighting mode upon determining, at the beginning of the receipt of electrical power following stoppage of the receipt of electrical power in step (a), that the operation mode recorded in step (a) is the messaging mode;
wherein, in the lighting mode, the light fixture controls the light emitting device to emit light with a predetermined brightness.

5. The method of claim 3, further comprising a step of: (c) operating in the lighting mode upon determining, at the beginning of the receipt of electrical power following stoppage of the receipt of electrical power in step (a), that the operation mode recorded in step (a) is the lighting mode and that the switch-on period recorded in step (a) is not shorter than the threshold period;
wherein, in the lighting mode, the light fixture controls the light emitting device to emit light with a predetermined brightness.

6. The method of claim 3, wherein, in the messaging mode, the light fixture further controls the light emitting device to operate in a third brightness state that indicates a beginning of the binary message;
wherein the light fixture controls light emission of the light emitting device such that brightness of light emitted by the light emitting device in the third brightness state is different from that in each of the first and second brightness states;
wherein, for each bit of the binary message, the light fixture controls the light emitting device to operate in a corresponding one of the first brightness state and the second brightness state for a first predetermined time length; and
wherein the light fixture controls the light emitting device to operate in the third brightness state for a second predetermined time length to indicate the beginning of the binary message.

7. The method of claim 6, wherein, in the messaging mode, the light fixture further controls the light emitting device to send, prior to sending the binary message, a binary header by operating in a sequence composed of the first brightness state, the second brightness state and/or the third brightness state.

8. The method of claim 7, wherein the binary message is a message after communication coding.

9. The method of claim 8, further comprising a step of: (c) receiving, by an image capturing device, light emitted by the light emitting device for decoding the binary message.

10. The method of claim 1, wherein step (b) includes operating in the messaging mode upon determining, at the beginning of receipt of electrical power following stoppage of the receipt of electrical power in step (a), that the operation mode recorded in step (a) is the lighting mode and that the switch-on period recorded in step (a) is longer than a first threshold period and shorter than a second threshold period.

11. The method of claim 10, wherein the lighting mode includes a plurality of lighting brightness states that are arranged in a predetermined sequence; and
wherein, in each of the lighting brightness states, the light fixture controls the light emitting device to emit light with a distinct brightness;
said method further comprising a step of: (c) operating in the lighting mode under a first one of the lighting brightness states upon determining, at the beginning of receipt of electrical power following stoppage of the receipt of electrical power in step (a), that the operation mode recorded in step (a) is the messaging mode.

12. The method of claim 11, further comprising a step of: (d) upon determining, at the beginning of receipt of electrical power following stoppage of the receipt of electrical power in step (a), that the operation mode recorded in step (a) is the lighting mode under an i^{th} one of the lighting brightness states, and that the switch-on period recorded in step (a) is not longer than the first threshold period, operating in the lighting mode under an (i+1)^{th} one of the lighting brightness states, where i is a positive integer smaller than a number of the lighting brightness states.

13. The method of claim 11, further comprising a step of: (d) upon determining, at the beginning of receipt of electrical power following stoppage of the receipt of electrical power in step (a), that the operation mode recorded in step (a) is the lighting mode under a last one of the lighting brightness states, and that the switch-on period recorded in step (a) is not longer than the first threshold period, operating in the lighting mode under the first one of the lighting brightness states.

14. The method of claim 11, further comprising a step of: (d) upon determining, at the beginning of receipt of electrical power following stoppage of the receipt of electrical power in step (a), that the operation mode recorded in step (a) is the lighting mode under one of the lighting brightness states and that the switch-on period recorded in step (a) is not shorter than the second threshold period, operating in the lighting mode under said one of the lighting brightness states thus determined.

15. The method of claim 11, wherein, in the messaging mode, the light fixture further controls the light emitting device to operate in a third brightness state that indicates a beginning of the binary message;
wherein the light fixture controls light emission of the light emitting device such that brightness of light emitted by the light emitting device in the third brightness state is different from that in each of the first and second brightness states;
wherein, for each bit of the binary message, the light fixture controls the light emitting device to operate in a corresponding one of the first brightness state and the second brightness state for a first predetermined time length; and
wherein, the light fixture controls the light emitting device to operate in the third brightness state for a second predetermined time length to indicate the beginning of the binary message.

16. The method of claim 15, wherein at least two of the first brightness state, the second brightness state or the third brightness state respectively correspond to at least two of the lighting brightness states in terms of brightness of light to be emitted by the light emitting device.

17. The method of claim 16, wherein, in the messaging mode, the light fixture further controls the light emitting device to send, prior to sending the binary message, a binary header by operating in a sequence composed of the first brightness state, the second brightness state and/or the third brightness state.

18. The method of claim 17, wherein the binary message is a message after communication coding.

19. The method of claim 18, further comprising a step of: (c) receiving, by an image capturing device, light emitted by the light emitting device for decoding the binary message.
